(19) United States
(12) Patent Application Publication
(10) Pub. No.: US 2004/0267929 A1
(43) Pub. Date: Dec. 30, 2004

(54) Method, system and computer program products for adaptive web-site access blocking

(75) Inventor: Michael Xie, Atherton, CA (US)

Correspondence Address: Bo-In Lin, 13445 Mandoli Drive, Los Altos Hills, CA, 94022, US

(73) Assignee: SERVGATE TECHNOLOGIES, INC

(21) Appl. No.: 10/609,193

(22) Filed: Jun. 27, 2003

(51) Int. Cl. G06F 15/173

(52) U.S. Cl. 709/225

(57) ABSTRACT

This invention discloses an Internet service gateway for controlling an access to an Internet web-site from a group of users. The service gateway includes a traffic logger for continuously monitoring a number of Internet accesses to each of a plurality of Internet web-sites from the group of users through the Internet service gateway for generating an Internet traffic log. The service gateway further includes a traffic analyzer for continuously counting and ranking the Internet accesses to each of the Internet web-sites and for generating a list of traffic-profile suspect Internet web-sites. The service gateway further includes an editor for allowing the access controller to edit a selection input for selecting the list of blocking web-sites among the list of traffic-profile suspect web-sites. The service gateway further includes a user interface to allow the access controller to provide entries directly to a list of blocking web-sites among the list of traffic-profile suspect web-sites.

### BACKGROUND OF THE INVENTION

1. Field of the Invention

This invention generally relates to managing the communication of data packets transmitted via an Internet or an Internet. More particularly, this invention is related to monitoring, logging and blocking data packets transmitted via an Intranet or Internet for adaptively carrying out a web access management.

2. Descriptions of the Reference Art As more and more web-sites are made available over the Internet, a person of ordinary skill in the art related to the field of web access management is confronted with a technical difficulty that monitoring and control of large volumes of accesses operations cannot be effectively administered. This difficulty becomes more pronounced as more accesses are made to continuously increasing and ever changing web-sites of different names associated by the commonly known term as universal resource locators (URLs). Network communications between computers connected through Internet or Intranet are becoming one of the most essential activities that most of the modern office workers engaged in almost every aspect of business and commercial interactions. By definition, a network is a group of computers and associated devices that are connected by communications facilities or links. Network connections can be of a permanent nature, such as via optical fibers, or can be of a temporary nature, such as connections made through telephone or other communication links. Networks vary in size, from a local area network (LAN) consisting of a few computers and related devices, to a wide area network (WAN) which interconnects computers and LANs that are geographically dispersed. An Internet network, in turn, is the joining of multiple computer networks, both similar and dissimilar, by means of gateways or routers that facilitate data transfer and conversion from various networks. A well-known network system is the “Internet system” that refers to the collection of networks and routers that use a Transmission Control Protocol/Internet Protocol (TCP/IP) to communicate with one another.

As many worldwide web, i.e., WWW sites on the Internet network system are providing useful information, particularly many of these sites are employment related information, many organizations are providing employees the benefit of browsing the WWW. However, there is also a need to control the access for limiting the usage to work-related topics only. A typical example is for a company engages in technology development to allow the employees to browse and keep up to date all the related technical information provided in different web-sites available on the Internet. In the meantime, proper control and monitoring must also be exercised such that abuse of the network access would not occur that may adversely affect employee's productivity, congest company's Internet access, and result in wastes of company's resources. Particularly, broad range of Internet web-sites are now available for almost every aspects of human interests and activities and policy of access control is often required to prevent unnecessary and undesirable abusive conducts.

A common solution now available in the market place is to use a software database, usually called universal resource locator (URL) blocking database to block users from visiting certain web-sites. There are commercial vendors providing such database products and services, such as WebSENSE, and similar programs to perform the URL blocking functions. The method that provided by these URL blocking programs is to use a network robot to wander the whole WWW periodically by sequentially following the web links. Then on each newly found web-site, a keyword match is applied or a manual examination and categorization according to the content of that site is performed to add site-relevant information into a URL blocking database. A web-access manager then applies such a database from the vendor in a server that control the Internet web-access for disallowing the employees to browse certain categories of web-sites. One example is to implement a policy to allow engineers to browse technologies, news, finance or other employment related web-sites, while disallow access to web-sites that are irrelevant to the duty of employment that may harm the company and the engineers because of legal issues or bandwidth limitations.

There are however several disadvantages and difficulties arising from such implementation. Specifically, the number and kinds of Internet web-sites is rapidly growing. New web-sites are generated while some older web-sites are eliminated. A database soon becomes obsolete because it does not realistically reflect the available web-sites to satisfy the need required by the policy implemented for controlling the web access. Additionally, because of the growth of the Internet, the size of such database will also grow rapidly. The speed to allow or block the web access when implemented with a large database may often become a bottleneck in the speed for web access. Furthermore, the Internet web-sites are now being created with different languages. Even that English web-sites dominate the original Internet applications, more and more non-English pages are now generated. A database of multiple languages is often difficult to generate and even more difficult for a database manager to perform the function of search and execute the URL blocking functions. Another difficulty is caused by the newly developed technology that more and more web-site pages are generated on the fly using internal database to assign URLs that are temporal and existing for only specific communication sessions. There is no effective method for the “network robot” to capture these names for the web-sites that should be blocked.

Therefore, a need still exits in the art to provide effective method and configuration to enable a person of ordinary skill in the art to resolve these difficulties. Specifically, the method and configuration must be able to adaptively change on a real-time basis according to continuously and momentary variations occur among many Internet users in accessing the web-sites to effectively administer and manage the web access control.

### SUMMARY OF THE PRESENT INVENTION

It is the object of the present invention to provide a new and improved method and system configuration to effectively and adaptively control the web-site access based on most up to date relevant traffic patterns from a group Internet users. An up to date traffic log is maintained for generating practical and useful lists of web-sites according to different rules of network traffic statistics. One exemplary rule may be a list of web-sites that have the highest network traffic volumes either in bytes of data or number of packets passed through. Another example may be a list of web-sites that are most frequently visited. These lists may be used for selecting a blocked and allowed lists for effectively and efficiently managing the web-site access operations from a group of Internet users. The difficulties and limitations as discussed above commonly encountered in the conventional techniques are resolved.

In one aspect of the present invention, methods, systems and computer software products are provided to effectively regulate the browsing activity of web users in a corporate environment, and avoid the above mentioned difficulties and limitations.

A preferred embodiment of this invention discloses an Internet service gateway for controlling an access to an Internet web-site from a group of users. The service gateway includes a traffic logger for continuously monitoring a number of Internet accesses to each of a plurality of Internet web-sites from the group of users through the Internet service gateway for generating an Internet traffic log. The service gateway further includes a traffic analyzer for continuously counting and ranking the Internet accesses to each of the Internet web-sites and for generating a list of web-sites as traffic profile suspect Internet web-sites statistically conforming to a blocking suspect traffic-profile. The service gateway further includes an editor for allowing the access controller to edit a selection input for selecting the list of blocking web-sites among the list traffic-profile suspect web-sites. The service gateway further includes a user interface to allow the access controller to provide (including but not limited to adding, editing, and deleting) the entries of the list of blocking web-sitesweb-site.

The invention also discloses a method for controlling an access to an Internet web-site from a group of users. The method includes a step of continuously logging and counting a number of Internet accesses to each of a plurality of Internet web-sites from the group of users through an Internet service gateway. The method further includes a step of statistically analyzing the pattern of Internet accesses for generating a list of traffic-profile suspect web-sites statistically conforming to a blocking-suspect traffic profile for selecting a list of blocking web-sites among the list of traffic-profile suspect web-sites.

These and other objects and advantages of the present invention will no doubt become obvious to those of ordinary skill in the art after having read the following detailed descriptions of the preferred embodiment that is illustrated in the various drawing figures.

### BRIEF DESCRIPTION OF THE DRAWINGS

FIG. 1 show a system configuration of a network system includes many computer users connected by a local area network (LAN) interfaced and controlled by an Internet service gateway to access the Internet.

FIG. 2 is a functional block diagram showing a hardware and software implementation of an Internet access control implemented in the Internet service gateway of FIG. 1.

### DETAILED DESCRIPTION OF THE METHOD

Reference will now be made in detail to the preferred embodiments of the invention. While the invention will be described in conjunction with the preferred embodiments, it will be understood that the inventions as disclosed are not intended to limit the invention to these embodiments. On the contrary, the invention is intended to cover alternatives, modifications and equivalents, which may be included within the spirit and scope of the invention. As will be appreciated by one of skill in the art, the present invention may be embodied as a method, data processing system or computer software program products. Accordingly, the present invention may take the form of data analysis systems, methods, analysis software and etc. Software written according to the present invention is to be stored in some form of computer readable medium, such as memory, or hard-drive, CD-ROM. The software of the invention may be transmitted over a network and executed by a processor in a remote location. The software may also be embedded in the computer readable medium of hardware, such as a network gateway device or a network card.

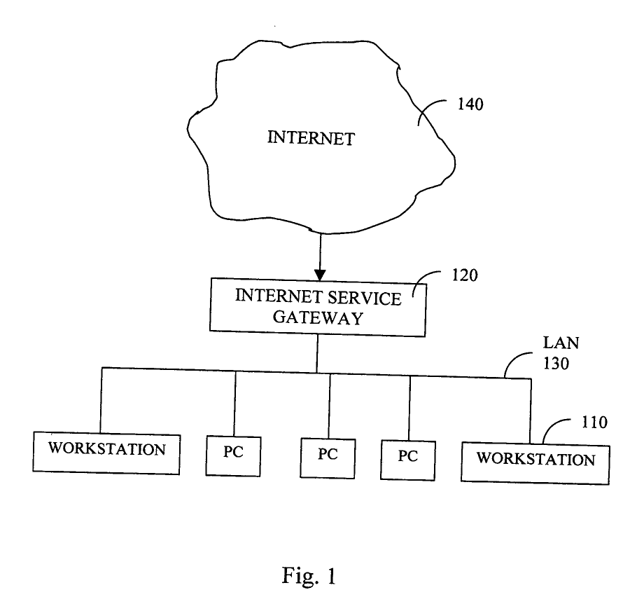

Referring to FIG. 1 for a system configuration for illustrating an Internet service gateway of this invention. The Internet service gateway is shown as a device 120 connected through a local area network (LAN) 130 to a group of computer users each operates a personal computer or computer workstation 110. The Internet service gateway 120 then connected to the Internet system 140 to interface and control the access from each of the computer users to communicate with many web-sites on the Internet 140. Usually a “firewall” is installed in the service gateway 120 to guard and control network traffic between the Internet 140 and networked computers 110 through the local area network (LAN) 130.

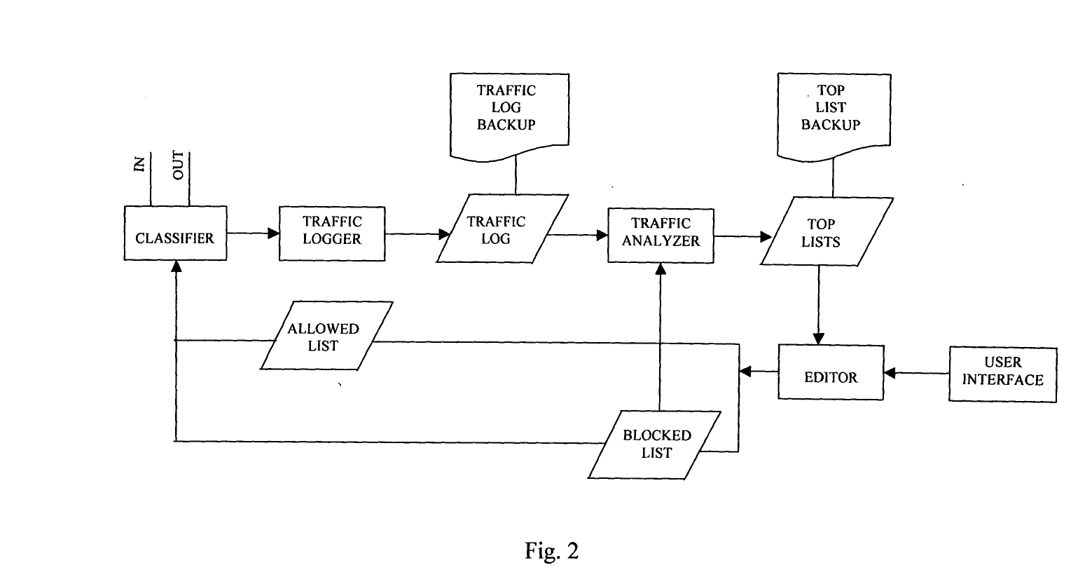

Referring to FIG. 2 for a software and hardware implementation of this invention. An adaptive URL blocking system is now configured with software and hardware functions shown respectively as parallelograms and rectangular blocks in FIG. 2. On the firewall implemented in the service gateway 120, a traffic logger is employed to log all the web accesses from internal network users 110 to generate a traffic log that is also backed up as a traffic log backup. All the Internet accesses are examined and the number of hits and traffic flows for each web-site visited are counted and statistically analyzed by a traffic analyzer to generate a top list as a list of traffic-profile suspect Internet web-sites. The list may include web-sites that the traffic patterns conform statistically to a blocking suspect traffic profile. As an example, the list may be a top list of the most frequently visited web-sites or a top list of most traffic generated web-sitesweb-site. The traffic analyzer implemented in the firewall has an option to periodically or on-demand produce a sub-list, showing the traffic-profile suspect Internet web-sites, for example, a top 10 sub-list of most frequently visited web-sites from a sorting and counting of the data provided by the traffic log. The top list is then provided through an editor or user interface to the firewall administrator. After examining the list, the administrator can select a blocking list of web-sites among the top list to disallow user access of the web-sites by inputting the selection list to the firewall. The firewall administer may also generate an allowed list to allow user access through the service gateway 120. These web-sites included in the allowed list are removed form the traffic-profile suspect web-sites such that the web-sites in the allowed list will not be in the top list as candidates of blocking. Once a blocking list is generated and implemented in the firewall, user access to the blocked web-sites on the Internet will be disallowed. In the meantime, a continuous monitoring and counting process is carried out to allow the firewall administer to update the disallowed or allowed list based on updated web-site access statistics. Therefore, the administrator can dynamically update the lists of blocked and allowed web-sites according to the user's traffic pattern. As a result, most of the unwanted traffic in a corporate environment will be blocked by this method, and regular traffic is not affected. This method can be carried out expeditiously without slowing down the gateway traffic because only a small database of unwanted sites are kept in storage on the firewall. Compared with the conventional method and configuration, the lookup speed for Internet traffic control is significantly improved. The firewall administer is also allow the flexibility to view and edit the list based on the most up to date information of the network traffic patterns. The network access policy can also be fine-tuned based on immediate need and requirements of the company operations.

According to above descriptions, an Internet service gateway for controlling an access to an Internet web-site from a group of users is disclosed. The service gateway includes an Internet traffic monitor for logging and analyzing a number of Internet accesses to each of a plurality of Internet websites from the group of users through the Internet service gateway. The service gateway further includes an Internet access blocking means for employing the pattern of Internet accesses for generating a list of traffic profile-suspect web-sites statistically conformed to a blocking-suspect-profile for selecting a list of blocking web-sites among the traffic-profile conforming list. In a preferred embodiment, the Internet traffic monitor further includes a traffic logger for continuously monitoring the Internet accesses and for generating an Internet traffic log. In a preferred embodiment, the Internet traffic monitor further includes a traffic analyzer for continuously counting and analyzing the Internet accesses to each of the Internet web-sites for generating the list of traffic profile-suspect Internet web-sites. In another preferred embodiment, the Internet access blocking means further includes a user interface for an access controller to provide (including but not limited to adding, editing and deleting) entries of the list of blocking web-sites. In another preferred embodiment, the Internet access blocking means further includes an editor for allowing the access controller to edit the selection input for selecting the list of blocking web-sites among the list of traffic profile-suspect web-sites. In another preferred embodiment, the user interface further allows the access controller to provide an access-allowed list for selecting a list of access-allowed web-sites for removing the access-allowed web-sites from the list of traffic profile-suspect web-sites. In another preferred embodiment, the traffic analyzer further includes a most frequently visited web-site counter for continuously counting and analyzing the Internet accesses to each of the Internet web-sites for generating a list of most frequently-visited web-sites for implementation as the list of traffic profile-suspect Internet web-sites. In another preferred embodiment, the traffic analyzer further includes a traffic-volume counter for continuously counting analyzing the Internet traffics to each of the Internet web-sites for generating a list of most traffic generated web-sites for implementation as the list of traffic profile-suspect Internet web-sites.

In essence, this invention discloses a Internet service gateway for controlling an access to a networked node from a group of users. The gateway includes a network traffic controller for continuously monitoring and analyzing accesses to a plurality of networked nodes from the group of users to enable an option for selectively blocking access to one of the networked nodes according to data obtained from continuously monitoring and analyzing the accesses.

This invention also discloses a method for controlling an access to a networked node from a group of users. The method includes a step of continuously monitoring and analyzing accesses to a plurality of networked nodes from the group of users to enable an option for selectively blocking access to one of the networked nodes according to data obtained from continuously monitoring and analyzing said accesses. In one of the preferred embodiment, the method further includes a step of allowing a gateway administer to select a blocking list for selectively blocking access to one of said networked nodes according to data obtained from continuously monitoring and analyzing said accesses.

Although the present invention has been described in terms of the presently preferred embodiment, it is to be understood that such disclosure is not to be interpreted as limiting. Various alterations and modifications will no doubt become apparent to those skilled in the art after reading the above disclosure. Accordingly, it is intended that the appended claims be interpreted as covering all alterations and modifications as fall within the true spirit and scope of the invention.

I claim:

1. An Internet service gateway for controlling an access to an Internet web-site from a group of users comprising:
an Internet traffic monitor for logging and analyzing a number of Internet accesses to each of a plurality of Internet web-sites from said group of users through said Internet service gateway; and
an Internet access blocking means for employing said number of Internet accesses for generating a list of traffic profile-suspect web-sites statistically conformed to a blocking-suspect-profile for selecting a list of blocking web-sites among said traffic-profile conforming list.

2. The Internet service gateway of claim 1 wherein:
said Internet traffic monitor further includes a traffic logger for continuously monitoring said Internet accesses and for generating an Internet traffic log.

3. The Internet service gateway of claim 1 wherein:
said Internet traffic monitor further includes a traffic analyzer for continuously counting and analyzing said Internet accesses to each of said Internet web-sites for generating said list of traffic profile-suspect Internet web-sites.

4. The Internet service gateway of claim 1 wherein:
said Internet access blocking means further includes a user interface for an access controller to provide a selection input for selecting said list of blocking web-sites among said list of traffic profile-suspect web-sites.

5. The Internet service gateway of claim 4 wherein:
said Internet access blocking means further includes an editor for allowing said access controller to edit said selection input for selecting said list of blocking web-sites among said list of traffic profile-suspect web-sites.

6. The Internet service gateway of claim 4 wherein:
said user interface further allows said access controller to provide an access-allowed list for selecting a list of access-allowed web-sites for removing said access-allowed web-sites from said list of traffic profile-suspect web-sites.

7. The Internet service gateway of claim 3 wherein:
said traffic analyzer further includes a most-frequently visited web-site counter for continuously counting and analyzing said Internet accesses to each of said Internet web-sites for generating a list of most frequently-visited web-sites for implementation as said list of traffic profile-suspect Internet web-sites.

8. The Internet service gateway of claim 3 wherein:
said traffic analyzer further includes a traffic-volume analyzer for continuously counting a traffic volume to each of said Internet web-sites for generating a list of most traffic-generated web-sites implementation as said list of traffic profile-suspect Internet web-sites.

9. An Internet service gateway for controlling an access to an Internet web-site from a group of users comprising:
a traffic logger for continuously monitoring a number of Internet accesses to each of a plurality of Internet web-sites from said group of users through said Internet service gateway for generating an Internet traffic log;
a traffic analyzer for continuously counting and analyzing said Internet traffic log for generating a list of traffic profile-suspect Internet web-sites statistically conformed to a blocking suspect traffic-profile;
an editor for allowing said access controller to edit a selection input for selecting said list of blocking web-sites among said list of traffic profile-suspect web-sites; and
a user interface to allow said access controller to provide said selection input to block access to a list of blocking web-sites among said list of traffic profile-suspect-web-sites.

10. An Internet service gateway for controlling an access to a networked node from a group of users comprising:
a network traffic controller for continuously monitoring and analyzing accesses to a plurality of networked nodes from said group of users to enable an option for selectively blocking access to one of said networked nodes according to data analyzed from continuously monitoring and analyzing of said accesses.

11. The Internet service gateway of claim 10 further comprising:
a gateway administer interface for enabling a gateway administer to select a blocking list for selectively blocking access to one of said networked nodes according to data obtained from continuously monitoring and analyzing said accesses.

12. A method for controlling an access to an Internet web-site from a group of users comprising:
continuously logging and analyzing a number of Internet accesses to each of a plurality of Internet web-sites from said group of users through an Internet service gateway; and
statistically analyzing said number of Internet accesses for generating a list of traffic profile-suspect web-sites statistically conformed to a blocking-suspect traffic profile for selecting a list of blocking web-sites among said list traffic profile-suspect web-sites.

13. The method of claim 12 wherein:
said step of continuously logging and analyzing said number of Internet accesses to each of said plurality of Internet web-sites further includes a step of employing a traffic logger for continuously monitoring said Internet accesses and for generating an Internet traffic log.

14. The method of claim 12 wherein:
said step of continuously logging and analyzing said number of Internet access to each of said plurality of Internet web-sites further includes a step of employing a traffic analyzer for continuously analyzing and ranking said Internet accesses to each of said Internet web-sites to generate said list of traffic profile-suspect Internet web-sites.

15. The method of claim 12 wherein:
said step of analyzing said number of Internet accesses for generating a list of traffic profile-suspect web-sites for selecting a list of blocking web-sites further includes a step of employing a user interface for allowing a gateway administer to provide entries of the list of blocking web-sites.

16. The method of claim 12 wherein:
said step of employing said number of Internet accesses for generating a list of traffic profile-suspect web-sites for selecting a list of blocking web-sites further includes a step of employing an editor for allowing said gateway administer to edit said selection input for selecting said list of blocking web-sites among said list of traffic profile-suspect web-sites.

17. The method of claim 16 wherein:
said step of employing an editor for allowing said gateway administer to edit said selection input further comprising a step of allowing said access controller to provide an access-allowed list for selecting a list of access-allowed web-sites for removing said access-allowed web-sites from said list of traffic profile-suspect web-sites.

18. The method of claim 15 wherein:
said step of employing said number of Internet accesses for generating a list of traffic profile-suspect web-sites for selecting a list of blocking web-sites further includes a step of generating a most-frequently visited web-site for implementation as said list of traffic profile-suspect Internet web-sites.

19. The method of claim 15 wherein:
said step of employing said number of Internet accesses for generating a list of traffic profile-suspect web-sites for selecting a list of blocking web-sites further includes a step of generating a list of most traffic-generated web-sites implementation as said list of traffic profile-suspect Internet web-sites through a step of continuously counting traffic volume to each of said Internet web-sites.

20. A method for controlling an access to an Internet web-site from a group of users comprising:
employing a traffic logger for continuously monitoring a number of Internet accesses to each of a plurality of Internet web-sites from said group of users through a Internet service gateway for generating an Internet traffic log;
employing a traffic analyzer for continuously counting and ranking said Internet accesses to each of said Internet web-sites and for generating a list of traffic profile-suspect Internet web-sites;
employing an editor for allowing said access controller to edit a selection input for selecting said list of blocking web-sites among said list of traffic profile-suspect web-sites; and
employing a user interface to allow said access controller to provide entries directly to a list of blocking web-sites among said list of traffic profile-suspect web-sites.

21. A method for controlling an access to a networked node from a group of users comprising:
continuously monitoring and analyzing accesses to a plurality of networked nodes from said group of users to enable an option for selectively blocking access to one of said networked nodes according to data obtained from continuously monitoring and analyzing said accesses.

22. The method of claim 21 further comprising:
allowing a gateway administer to select a blocking list for selectively blocking access to one of said networked nodes according to data obtained from continuously monitoring and analyzing said accesses.
